(19) United States
(12) Patent Application Publication
(10) Pub. No.: US 2017/0080529 A1
(43) Pub. Date: Mar. 23, 2017

(54) METHOD FOR REPAIRING AN AIRFOIL, AND COOLING COLLAR

(71) Applicant: SIEMENS AKTIENGESELLSCHAFT, MÜNCHEN (DE)

(72) Inventors: NIKOLAI ARJAKINE, BERLIN (DE); GEORG BOSTANJOGLO, BERLIN (DE); BERND BURBAUM, FALKENSEE (DE); ROMAN KALOCSAY, AACHEN (DE)

(21) Appl. No.: 15/311,201

(22) PCT Filed: Apr. 28, 2015
(86) PCT No.: PCT/EP2015/059166

§ 371 Date: Nov. 15, 2016

(30) Foreign Application Priority Data
May 23, 2014 (DE) 10 2014 209 847.5

(51) Int. Cl. B23P 6/00; F01D 9/02; F01D 5/00; F01D 5/12; B23K 26/342; B23K 26/70

(52) U.S. Cl. CPC B23P 6/002; B23K 26/342; B23K 26/703; F01D 5/005; F01D 5/12; F01D 9/02; B23K 2201/001

(57) ABSTRACT

A method for repairing an airfoil of an axial turbomachine in which material is deposited onto the airfoil by means of deposition welding, the airfoil being cooled during the deposition welding, is provided. A cooling collar including at least one cooling channel which has a coolant inlet and a coolant outlet and through which a coolant flows in the intended state, is also provided. The cooling collar also includes multiple cooling elements which are arranged along an inner circumference of the cooling collar and adjacently to the at least one cooling channel, the cooling elements resting against an object to be cooled, in particular an airfoil to be cooled, in the intended state.

### CROSS-REFERENCE TO RELATED APPLICATIONS

This application claims priority to PCT Application No. PCT/EP2015/059166, having a filing date of Apr. 28, 2015, based off of DE Application No. 102014209847.5 having a filing date of May 23, 2014, the entire contents of which are hereby incorporated by reference.

### FIELD OF TECHNOLOGY

The following relates to a method for repairing an airfoil of an axial turbomachine, in which material is applied to the airfoil by means of deposition welding.

### BACKGROUND

During operation, airfoils of axial turbomachines, such as for example the rotor blades of gas turbines, are often exposed to very high temperatures and high levels of thermal loading. For this reason, airfoils are produced from high-strength materials, such as for example from a nickel-based superalloy. In spite of such high-strength materials, however, it is not possible to prevent wear to the airfoils as a result of oxidation, thermal fatigue cracking, metal erosion or the like. Accordingly, the airfoils have to be maintained at regular intervals and, in the case of wear, replaced or repaired.

For repairing airfoils, there are a wide variety of repair methods in which material is applied by means of deposition welding to worn regions of an airfoil or to regions of an airfoil from which material has been mechanically removed previously. Methods used here, for example, are laser deposition welding and plasma powder deposition welding, to name just a couple of examples. The applied material can correspond to the original material. As an alternative, however, it is also possible for a different high-strength material to be applied.

One problem in the case of known repair methods consists in the fact that the deposition welding introduces heat into the airfoil to be repaired, as a result of which residual welding stresses are brought about in the component; these can lead inter alia to cracks. One possible way to counter such residual welding stresses consists, for example, in preheating the component before the welding, as a result of which residual welding stresses are reduced by relaxation during the welding process. Alternatively, it is possible to choose welding methods in which relatively little heat is introduced into the substrate, such as for example laser deposition welding, to name just one example. A further problem of known repair methods consists in the fact that, if a plurality of material layers are to be applied one on top of another, the previously generated material layer first has to cool down in order to keep the process conditions constant, and this is associated with long idle periods.

### SUMMARY

An aspect relates to an alternative method for repairing an airfoil of an axial turbomachine of the type mentioned in the introduction.

Another aspect relates to a method of the type mentioned in the introduction, which is characterized in that the airfoil is cooled during the deposition welding. A significant advantage of such cooling during the deposition welding consists in the fact that the heat introduced into the component by the welding process is dissipated quickly, and this leads to very constant process conditions. In addition, it is possible to avoid idle periods between the welding of welded layers arranged one on top of another.

It is preferable in the method according to embodiments of the invention that side wall regions of the airfoil are cooled during the deposition welding. Large-area and efficient cooling can correspondingly be achieved.

According to one variant of the method according to embodiments of the invention, the material is applied at least to the blade or vane tip. In this way, for example, it is possible to eliminate damage to the blade or vane tip which can be attributed to operational contact between the blade or vane tip and a stationary seal or a stationary housing.

It is preferable that side wall regions of the airfoil which are arranged adjacent to the blade or vane tip are cooled during the deposition welding. Accordingly, very efficient cooling is achieved during the application of material to the blade or vane tip.

In the method according to embodiments of the invention, the material is advantageously applied by means of micropowder deposition welding, this also being referred to as micro-cladding. In this method, a continuous stream of powder is melted onto the substrate using a focused laser, in particular a fiber laser, as a result of which it is possible to produce areal coatings in layers or else targeted structures. A significant advantage of micropowder deposition welding consists in the fact that only little heat is introduced into the component, and therefore stresses scarcely arise. In addition, the achievable application of material is very precise, and therefore only minor reworking follows the application of material.

Furthermore, embodiments of the present invention provide a cooling collar, which is suitable in particular for carrying out the method according to embodiments of the invention. The cooling collar comprises at least one cooling channel, which has a coolant inlet and a coolant outlet and through which a coolant flows in the intended state, and also a plurality of cooling elements, which are arranged along an inner wall of the cooling collar and adjoining the at least one cooling channel and which rest against an object to be cooled in the intended state. A cooling collar of this type can easily be arranged on the circumference of an object to be cooled and bring about effective cooling via the cooling elements which are cooled by the coolant flowing through the at least one cooling channel.

According to one embodiment of the present invention, the cooling elements are held movably on the cooling collar.

It thereby becomes possible to orient the cooling elements in relation to an object to be cooled, as a result of which it is possible to ensure a good contact between the cooling elements and the object to be cooled and accordingly a good transfer of heat.

According to one variant of the invention, flexible sealing elements are arranged between the respective cooling elements and allow for a movement of the cooling elements. At the same time, the sealing elements prevent the coolant flowing through the cooling channel from escaping between the cooling elements.

The cooling elements are preferably produced from a metallic material, in particular from aluminum. Metallic materials and in particular aluminum are distinguished by their good thermal conductivity.

Advantageously, the arrangement, the number and the shape of the cooling elements are matched to the outer contour of an airfoil to be cooled, in particular to the outer contour of side wall regions of the airfoil which are arranged adjacent to the blade or vane tip. In other words, the cooling collar is preferably designed for cooling side wall regions of an airfoil of a turbomachine, in particular for cooling a guide vane of a gas turbine.

According to one embodiment of the present invention, a housing which defines the at least one cooling channel and accommodates the cooling elements is provided.

The housing is preferably provided with a clamping device, which is formed in such a manner that it presses the cooling elements against the object to be cooled in the intended state. Firstly, this ensures a good transfer of heat between the cooling elements and the object to be cooled. Secondly, the cooling collar can be pushed onto an object to be cooled and then fixed firmly thereto with the activation of the clamping device.

According to one variant of the present invention, the housing is divided in the circumferential direction into two housing portions, which divide the cooling channel and are connected to one another via an elastic connecting element which defines a coolant passage, wherein the clamping device connects free ends of the housing portions to one another.

### BRIEF DESCRIPTION

Some of the embodiments will be described in detail, with reference to the following figures, wherein like designations denote like members, wherein:

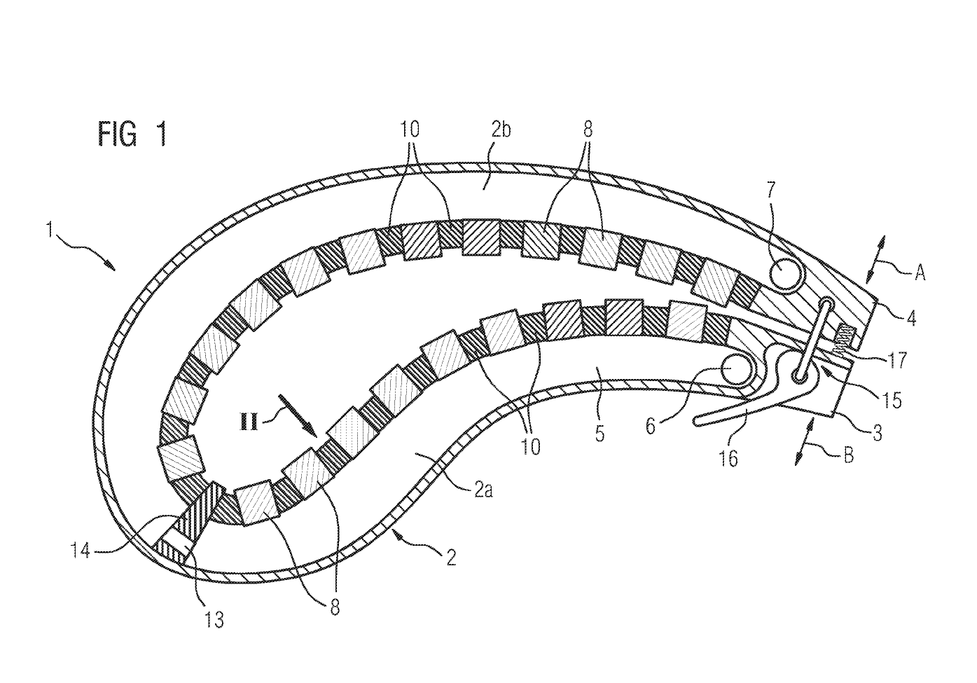

FIG. 1 is a schematic sectional plan view of a cooling collar according to one embodiment of the present invention;

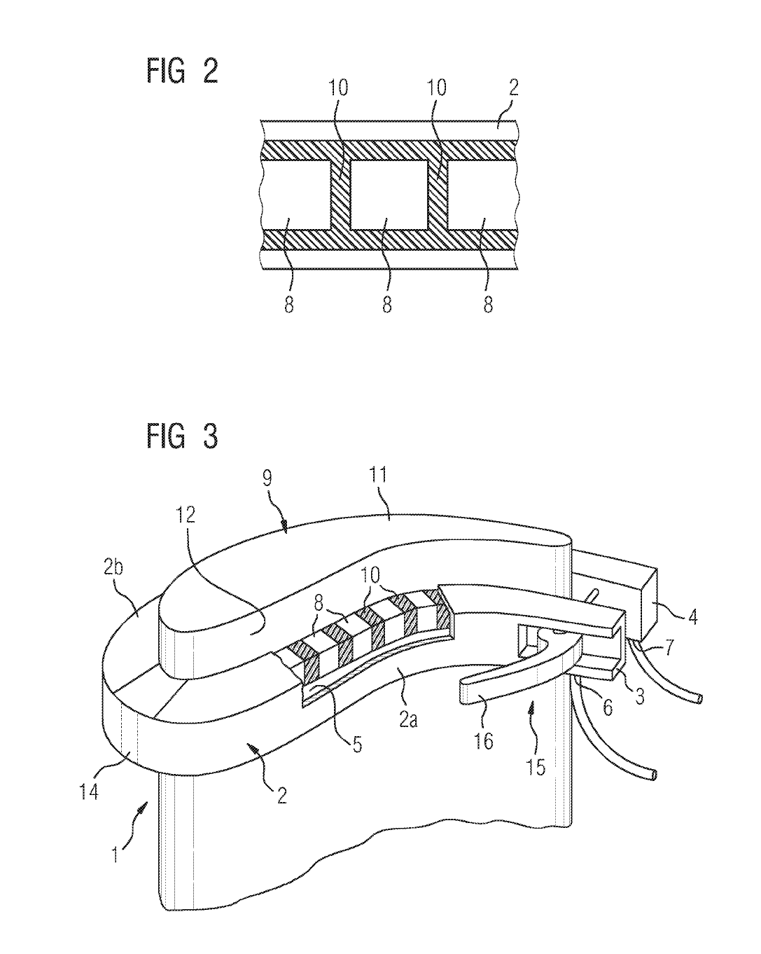

FIG. 2 is a partial view of the cooling collar shown in FIG. 1 in the direction of the arrow II in FIG. 1; and

FIG. 3 is a schematic perspective view of the cooling collar shown in FIG. 1, which is arranged on an airfoil to be cooled.

### DETAILED DESCRIPTION

The Figures show a cooling collar 1 according to one embodiment of the present invention. The cooling collar 1 comprises an elongate housing 2 extending like a kidney and with mutually opposing free housing ends 3 and 4. A cooling channel 5 extends in the housing 2 and is provided with a coolant inlet 6 at one free housing end 3 and with a coolant outlet 7 at the other free housing end 4. The cooling collar 1 furthermore comprises a plurality of cooling elements 8, which are arranged along an inner wall of the cooling collar 1 and adjoining the cooling channel 5 and, in the intended state, rest against an airfoil 9 of a turbomachine, as will be explained in even more detail hereinbelow.

The cooling elements 8 are produced from a metallic material, in particular from aluminum, which is distinguished by its good thermal conductivity. Flexible sealing elements 10 are arranged between the respective cooling elements 8 and on the one hand seal off the intermediate spaces between the cooling elements 8 in order to prevent a coolant guided through the cooling channel 5 from escaping through these intermediate spaces. On the other hand, the sealing elements 10, which circumferentially surround the cooling elements 8, give the cooling elements 8 a certain mobility. The arrangement, the number and the shape of the cooling elements 8 are matched to the outer contour of the airfoil 9 to be cooled, more precisely to the outer contour of side wall regions 12 of the airfoil 9 which are arranged adjacent to the blade or vane tip 11. The housing 2 is divided approximately centrally in the circumferential direction into two housing portions 2a, 2b, which divide the cooling channel 5 and are connected to one another via an elastic connecting element 14 which defines a coolant passage 13. Owing to the elasticity of the connecting element 14, the housing portions 2a and 2b can be moved in relation to one another within certain limits in the direction of the arrows A and B. The free housing ends 3 and 4 are connected to one another by a clamping device 15. The clamping device 15 comprises a clamping lever 16 and a spring 17 extending between the housing ends 3 and 4, and is formed in such a manner that, upon actuation of the clamping lever 16, the housing ends 3 and 4 can be moved toward one another counter to the force of the spring 17, and can be moved away from one another with the assistance of the force of the spring 17.

The cooling collar 1 serves to cool the side wall regions 12 of an airfoil 9 while material is applied to the blade or vane tip 11 of the airfoil 9 by means of deposition welding in the course of a repair method.

To carry out the method, in a first step, the cooling collar 1 is mounted on the airfoil 9. To this end, the clamping lever 16 of the clamping device 15 is released, such that the cooling collar 1 can be pushed from above onto the airfoil 9. In the process, the cooling collar 1 is positioned in such a manner that the cooling elements 8 come into engagement with the side wall regions 12 of the airfoil 9 which are arranged adjacent to the blade or vane tip 11. As soon as the cooling collar 1 is arranged at its intended position, the clamping device 15 is tensioned counter to the force of the spring 17 with actuation of the clamping lever 16, as is shown in FIG. 3, such that the individual cooling elements 8 are pressed against the opposing portions of the side wall regions 12 of the airfoil 9. Owing to the flexibility of the sealing elements which border the cooling elements 8, the cooling elements 8 are automatically optimally oriented in relation to the outer contour of the side wall regions 12 in the course of this clamping operation, as a result of which a good transfer of heat between the airfoil 9 and the cooling elements 8 is ensured.

In a further step, a coolant is fed to the cooling channel 5 via the coolant inlet 6, said coolant flowing through the cooling channel 5 and emerging again from the cooling collar 1 through the coolant outlet 7.

Then, the airfoil repair method is carried out. In this respect, material is applied to the blade or vane tip 11 of the airfoil 9 by means of micropowder deposition welding. The heat which is fed to the airfoil 9 during the welding process is transferred from the side wall regions 12 of the airfoil 9 via the cooling elements 8 to the coolant flowing through the cooling channel 5, and dissipated.

A significant advantage of such cooling during the deposition welding consists in the fact that the heat introduced into the component by the welding process is dissipated more quickly, and this leads to very constant process conditions.

In addition, it is possible to avoid idle periods between the welding of welded layers arranged one on top of another.

The cooling collar 1 according to the embodiments of the invention is distinguished in particular by the fact that it has a simple and inexpensive structure which occupies little construction space. Accordingly, the cooling collar 1 can be transported easily and used flexibly. It is also possible to carry out a repair method on an airfoil 9 which is still installed in situ using the cooling collar 1 according to embodiments of the invention.

The repair method according to embodiments of the invention is preferably carried out using micropowder deposition welding. A significant advantage of micropowder deposition welding consists in the fact that only little heat is introduced into the component, and this can easily be dissipated via the cooling collar, and therefore stresses scarcely arise. In addition, the achievable application of material is very precise, and therefore only minor reworking follows the application of material.

A wide variety of materials can be selected for the application of material. Thus, by way of example, the applied material may be a base material of the airfoil, a protective coating or the like. Suitable materials are well known to a person skilled in the art, and therefore no further details are provided in relation thereto.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

### Method for Repairing an Airfoil, and Cooling Collar

The present invention relates to a method for repairing an airfoil of an axial turbomachine, in which material is applied to the airfoil by means of deposition welding.

During operation, airfoils of axial turbomachines, such as for example the rotor blades of gas turbines, are often exposed to very high temperatures and high levels of thermal loading. For this reason, airfoils are produced from high-strength materials, such as for example from a nickel-based superalloy. In spite of such high-strength materials, however, it is not possible to prevent wear to the airfoils as a result of oxidation, thermal fatigue cracking, metal erosion or the like. Accordingly, the airfoils have to be maintained at regular intervals and, in the case of wear, replaced or repaired.

For repairing airfoils, there are a wide variety of repair methods in which material is applied by means of deposition welding to worn regions of an airfoil or to regions of an airfoil from which material has been mechanically removed previously. Methods used here, for example, are laser deposition welding and plasma powder deposition welding, to name just a couple of examples. The applied material can correspond to the original material. As an alternative, however, it is also possible for a different high-strength material to be applied.

One problem in the case of known repair methods consists in the fact that the deposition welding introduces heat into the airfoil to be repaired, as a result of which residual welding stresses are brought about in the component; these can lead inter alia to cracks. One possible way to counter such residual welding stresses consists, for example, in preheating the component before the welding, as a result of which residual welding stresses are reduced by relaxation during the welding process. Alternatively, it is possible to choose welding methods in which relatively little heat is introduced into the substrate, such as for example laser deposition welding, to name just one example. A further problem of known repair methods consists in the fact that, if a plurality of material layers are to be applied one on top of another, the previously generated material layer first has to cool down in order to keep the process conditions constant, and this is associated with long idle periods.

Proceeding from this prior art, it is an object of the present invention to provide an alternative method for repairing an airfoil of an axial turbomachine of the type mentioned in the introduction.

To achieve this object, the present invention provides a method of the type mentioned in the introduction, which is characterized in that the airfoil is cooled during the deposition welding. A significant advantage of such cooling during the deposition welding consists in the fact that the heat introduced into the component by the welding process is dissipated quickly, and this leads to very constant process conditions. In addition, it is possible to avoid idle periods between the welding of welded layers arranged one on top of another.

It is preferable in the method according to the invention that side wall regions of the airfoil are cooled during the deposition welding. Large-area and efficient cooling can correspondingly be achieved.

According to one variant of the method according to the invention, the material is applied at least to the blade or vane tip. In this way, for example, it is possible to eliminate damage to the blade or vane tip which can be attributed to operational contact between the blade or vane tip and a stationary seal or a stationary housing.

It is preferable that side wall regions of the airfoil which are arranged adjacent to the blade or vane tip are cooled during the deposition welding. Accordingly, very efficient cooling is achieved during the application of material to the blade or vane tip.

In the method according to the invention, the material is advantageously applied by means of micropowder deposition welding, this also being referred to as micro-cladding. In this method, a continuous stream of powder is melted onto the substrate using a focused laser, in particular a fiber laser, as a result of which it is possible to produce areal coatings in layers or else targeted structures. A significant advantage of micropowder deposition welding consists in the fact that only little heat is introduced into the component, and therefore stresses scarcely arise. In addition, the achievable application of material is very precise, and therefore only minor reworking follows the application of material.

Furthermore, the present invention provides a cooling collar, which is suitable in particular for carrying out the method according to the invention. The cooling collar comprises at least one cooling channel, which has a coolant inlet and a coolant outlet and through which a coolant flows in the intended state, and also a plurality of cooling elements, which are arranged along an inner wall of the cooling collar and adjoining the at least one cooling channel and which rest against an object to be cooled in the intended state. A cooling collar of this type can easily be arranged on the circumference of an object to be cooled and bring about effective cooling via the cooling elements which are cooled by the coolant flowing through the at least one cooling channel.

According to one embodiment of the present invention, the cooling elements are held movably on the cooling collar.

It thereby becomes possible to orient the cooling elements in relation to an object to be cooled, as a result of which it is possible to ensure a good contact between the cooling elements and the object to be cooled and accordingly a good transfer of heat.

According to one variant according to the invention, flexible sealing elements are arranged between the respective cooling elements and allow for a movement of the cooling elements. At the same time, the sealing elements prevent the coolant flowing through the cooling channel from escaping between the cooling elements.

The cooling elements are preferably produced from a metallic material, in particular from aluminum. Metallic materials and in particular aluminum are distinguished by their good thermal conductivity.

Advantageously, the arrangement, the number and the shape of the cooling elements are matched to the outer contour of an airfoil to be cooled, in particular to the outer contour of side wall regions of the airfoil which are arranged adjacent to the blade or vane tip. In other words, the cooling collar is preferably designed for cooling side wall regions of an airfoil of a turbomachine, in particular for cooling a guide vane of a gas turbine.

According to one embodiment of the present invention, a housing which defines the at least one cooling channel and accommodates the cooling elements is provided.

The housing is preferably provided with a clamping device, which is formed in such a manner that it presses the cooling elements against the object to be cooled in the intended state. Firstly, this ensures a good transfer of heat between the cooling elements and the object to be cooled. Secondly, the cooling collar can be pushed onto an object to be cooled and then fixed firmly thereto with the activation of the clamping device.

According to one variant of the present invention, the housing is divided in the circumferential direction into two housing portions, which divide the cooling channel and are connected to one another via an elastic connecting element which defines a coolant passage, wherein the clamping device connects free ends of the housing portions to one another.

Further features and advantages of the present invention will become clear on the basis of the following description of a cooling collar according to one embodiment of the present invention with reference to the accompanying drawing, in which:

FIG. 1 is a schematic sectional plan view of a cooling collar according to one embodiment of the present invention;

FIG. 2 is a partial view of the cooling collar shown in FIG. 1 in the direction of the arrow II in FIG. 1, and

FIG. 3 is a schematic perspective view of the cooling collar shown in FIG. 1, which is arranged on an airfoil to be cooled.

The figures show a cooling collar 1 according to one embodiment of the present invention. The cooling collar 1 comprises an elongate housing 2 extending like a kidney and with mutually opposing free housing ends 3 and 4. A cooling channel 5 extends in the housing 2 and is provided with a coolant inlet 6 at one free housing end 3 and with a coolant outlet 7 at the other free housing end 4. The cooling collar 1 furthermore comprises a plurality of cooling elements 8, which are arranged along an inner wall of the cooling collar 1 and adjoining the cooling channel 5 and, in the intended state, rest against an airfoil 9 of a turbomachine, as will be explained in even more detail hereinbelow.

The cooling elements 8 are produced from a metallic material, in particular from aluminum, which is distinguished by its good thermal conductivity. Flexible sealing elements 10 are arranged between the respective cooling elements 8 and on the one hand seal off the intermediate spaces between the cooling elements 8 in order to prevent a coolant guided through the cooling channel 5 from escaping through these intermediate spaces. On the other hand, the sealing elements 10, which circumferentially surround the cooling elements 8, give the cooling elements 8 a certain mobility. The arrangement, the number and the shape of the cooling elements 8 are matched to the outer contour of the airfoil 9 to be cooled, more precisely to the outer contour of side wall regions 12 of the airfoil 9 which are arranged adjacent to the blade or vane tip 11. The housing 2 is divided approximately centrally in the circumferential direction into two housing portions 2a, 2b, which divide the cooling channel 5 and are connected to one another via an elastic connecting element 14 which defines a coolant passage 13. Owing to the elasticity of the connecting element 14, the housing portions 2a and 2b can be moved in relation to one another within certain limits in the direction of the arrows A and B. The free housing ends 3 and 4 are connected to one another by a clamping device 15. The clamping device 15 comprises a clamping lever 16 and a spring 17 extending between the housing ends 3 and 4, and is formed in such a manner that, upon actuation of the clamping lever 16, the housing ends 3 and 4 can be moved toward one another counter to the force of the spring 17, and can be moved away from one another with the assistance of the force of the spring 17.

The cooling collar 1 serves to cool the side wall regions 12 of an airfoil 9 while material is applied to the blade or vane tip 11 of the airfoil 9 by means of deposition welding in the course of a repair method.

To carry out the method, in a first step, the cooling collar 1 is mounted on the airfoil 9. To this end, the clamping lever 16 of the clamping device 15 is released, such that the cooling collar 1 can be pushed from above onto the airfoil 9. In the process, the cooling collar 1 is positioned in such a manner that the cooling elements 8 come into engagement with the side wall regions 12 of the airfoil 9 which are arranged adjacent to the blade or vane tip 11. As soon as the cooling collar 1 is arranged at its intended position, the clamping device 15 is tensioned counter to the force of the spring 17 with actuation of the clamping lever 16, as is shown in FIG. 3, such that the individual cooling elements 8 are pressed against the opposing portions of the side wall regions 12 of the airfoil 9. Owing to the flexibility of the sealing elements which border the cooling elements 8, the cooling elements 8 are automatically optimally oriented in relation to the outer contour of the side wall regions 12 in the course of this clamping operation, as a result of which a good transfer of heat between the airfoil 9 and the cooling elements 8 is ensured.

In a further step, a coolant is fed to the cooling channel 5 via the coolant inlet 6, said coolant flowing through the cooling channel 5 and emerging again from the cooling collar 1 through the coolant outlet 7.

Then, the airfoil repair method is carried out. In this respect, material is applied to the blade or vane tip 11 of the airfoil 9 by means of micropowder deposition welding. The heat which is fed to the airfoil 9 during the welding process is transferred from the side wall regions 12 of the airfoil 9 via the cooling elements 8 to the coolant flowing through the cooling channel 5, and dissipated.

A significant advantage of such cooling during the deposition welding consists in the fact that the heat introduced into the component by the welding process is dissipated more quickly, and this leads to very constant process conditions.

In addition, it is possible to avoid idle periods between the welding of welded layers arranged one on top of another.

The cooling collar 1 according to the invention is distinguished in particular by the fact that it has a simple and inexpensive structure which occupies little construction space. Accordingly, the cooling collar 1 can be transported easily and used flexibly. It is also possible to carry out a repair method on an airfoil 9 which is still installed in situ using the cooling collar 1 according to the invention.

The repair method according to the invention is preferably carried out using micropowder deposition welding. A significant advantage of micropowder deposition welding consists in the fact that only little heat is introduced into the component, and this can easily be dissipated via the cooling collar, and therefore stresses scarcely arise. In addition, the achievable application of material is very precise, and therefore only minor reworking follows the application of material.

A wide variety of materials can be selected for the application of material. Thus, by way of example, the applied material may be a base material of the airfoil, a protective coating or the like. Suitable materials are well known to a person skilled in the art, and therefore no further details are provided in relation thereto.

Although the invention has been illustrated and described in more detail by the preferred exemplary embodiment, the invention is not limited by the disclosed examples, and other variations can be derived therefrom by a person skilled in the art without departing from the scope of protection of the invention.

1. A method for repairing an airfoil of an axial turbomachine, in which material is applied to the airfoil by means of deposition welding, wherein the airfoil is cooled during the deposition welding.

2. The method as claimed in claim 1, wherein side wall regions of the airfoil are cooled during the deposition welding.

3. The method as claimed in claim 1, wherein material is applied at least to a blade or vane tip.

4. The method as claimed in claim 3, wherein the side wall regions of the airfoil which are arranged adjacent to the blade or vane tip are cooled during the deposition welding.

5. The method as claimed in claim 1, wherein the material is applied by means of micropowder deposition welding.

6. A cooling collar comprising:
at least one cooling channel, which has a coolant inlet and a coolant outlet and through which a coolant flows in an intended state and
a plurality of cooling elements, which are arranged along an inner wall of the cooling collar and adjoining the at least one cooling channel and which rest against an object to be cooled in the intended state.

7. The cooling collar as claimed in claim 6, wherein the plurality of cooling elements are held movably.

8. The cooling collar as claimed in claim 7, wherein a plurality of flexible sealing elements are arranged between the respective plurality of cooling elements and allow for a movement of the plurality of cooling elements.

9. The cooling collar as claimed in claim 6, wherein the plurality of cooling elements are produced from a metallic material.

10. The cooling collar as claimed in claim 6, wherein an arrangement, a number and a shape of the plurality of cooling elements are matched to an outer contour of an airfoil to be cooled.

11. The cooling collar as claimed in claim 6, wherein a housing which defines the at least one cooling channel and accommodates the plurality of cooling elements is provided.

12. The cooling collar as claimed in claim 11, wherein the housing is provided with a clamping device, which is formed in such a manner that the clamping device presses the plurality of cooling elements against the object to be cooled in the intended state.

13. The cooling collar as claimed in claim 12, wherein the housing is divided in a circumferential direction into two housing portions, which divide the at least one cooling channel and are connected to one another via an elastic connecting element which defines a coolant passage, and in that the clamping device connects free ends of the housing portions to one another.

14. The cooling collar as claimed claim 9, wherein the plurality of cooling elements are produced from aluminum.

15. The cooling collar as claimed in claim 10, wherein the arrangement, the number and the shape of the plurality of cooling elements are matched to the outer contour side wall regions arranged adjacent to a blade or a vane tip.
